(19) United States
(12) Patent Application Publication
(10) Pub. No.: US 2006/0143070 A1
(43) Pub. Date: Jun. 29, 2006

(54) Lubricants product management system

(75) Inventors: Colin C. Burnett, Dewsbury (GB); Brian Hayes, Glasgow (GB)

Correspondence Address: CHEVRON TEXACO CORPORATION, P.O. BOX 6006, SAN RAMON, CA, 94583-0806, US

(73) Assignee: Texaco Limited

(21) Appl. No.: 11/025,622

(22) Filed: Dec. 28, 2004

(51) Int. Cl. G06F 17/30

(52) U.S. Cl. 705/10

(57) ABSTRACT

The invention includes a method for lubricating oils product management including: inputting alphanumeric data into one or more data structures, the data structures configured and adapted for storing, updating, modifying, deleting, and searching data including historical lubricant management costs, historical lubricants volume consumption, projected lubricants volume consumption, projected lubricant management costs, and mixtures thereof; searching at least one of the data structures where the search parameters are selected by a user and include historical date ranges, future date ranges, and mixtures thereof; and forecasting future projections over the user selected future date ranges, the future projections including projected lubricants volume consumption, projected lubricant management costs, and mixtures thereof; where the input for the forecasting includes historical lubricant management costs, historical lubricants volume consumption, and mixture thereof; and displaying on a monitor one or more graphical representations, where the graphical representations include the results of the search of the at least one data structure, the results of the forecasting, and mixtures thereof; where the graphical representations depict historical lubricant management costs, historical lubricants volume consumption, projected lubricants volume consumption, projected lubricant management costs, and mixtures thereof.

### I. COPYRIGHT NOTICE AND AUTHORIZATION

This patent document contains material which is subject to copyright protection.

©Copyright 2004. Texaco Limited. All rights reserved.

With respect to this material which is subject to copyright protection. The owner, Texaco Limited, has no objection to the facsimile reproduction by any one of the patent disclosure, as it appears in the Patent and Trademark Office patent files or records of any country, but otherwise reserves all rights whatsoever.

### II. FIELD OF THE INVENTION

The invention relates to computer-implemented process and system for a lubricating oil management system.

### III. BACKGROUND OF THE INVENTION

Fluid management, in particular management of lubricating oils, is an important function in many industries which depend on various motor vehicles, generators, motors, manufacturing equipment, and other various pieces of machinery which require lubrication. Each piece of equipment may require a different lubricating product and have a different maintenance schedule. Both the business using the lubricating oils and the business supplying the lubricating oils would benefit from a system which provides an efficient and accurate means to evaluate costs, prepare proposals, measure performance levels, track efficiency and set key performance indicators for review. The instant invention provides such a solution.

### IV. SUMMARY OF THE INVENTION

The proposed invention in one embodiment is a method for lubricating oils product management including: inputting alphanumeric data into one or more data structures, the data structures configured and adapted for storing, updating, modifying, deleting, and searching data including historical lubricant management costs, historical lubricants volume consumption, projected lubricants volume consumption, projected lubricant management costs, and mixtures thereof; searching at least one of the data structures where the search parameters are selected by a user and include historical date ranges, future date ranges, and mixtures thereof; and forecasting future projections over the user selected future date ranges, the future projections including projected lubricants volume consumption, projected lubricant management costs, and mixtures thereof; where the input for the forecasting includes historical lubricant management costs, historical lubricants volume consumption, and mixture thereof; and displaying on a monitor one or more graphical representations, where the graphical representations include the results of the search of the at least one data structure, the results of the forecasting, and mixtures thereof; where the graphical representations depict historical lubricant management costs, historical lubricants volume consumption, projected lubricants volume consumption, projected lubricant management costs, and mixtures thereof.

Another embodiment of the invention includes a the system including: a CPU; a memory operatively connected to the CPU, the memory containing a program adapted to be executed by the CPU and the CPU and memory cooperatively adapted for lubricating oils product management; a lubricating oils product management code segment embodied on a computer-readable medium configured and adapted for: inputting alphanumeric data into one or more data structures, the data structures configured and adapted for storing, updating, modifying, deleting, and searching data including historical lubricant management costs, historical lubricants volume consumption, projected lubricants volume consumption, projected lubricant management costs, and mixtures thereof; searching at least one of the data structures where the search parameters are selected by a user and include historical date ranges, future date ranges, and mixtures thereof; and forecasting future projections over the user selected future date ranges, the future projections including projected lubricants volume consumption, projected lubricant management costs, and mixtures thereof; where the input for the forecasting includes historical lubricant management costs, historical lubricants volume consumption, and mixture thereof; and displaying on a monitor one or more graphical representations, where the graphical representations include the results of the search of the at least one data structure, the results of the forecasting, and mixtures thereof; where the graphical representations depict historical lubricant management costs, historical lubricants volume consumption, projected lubricants volume consumption, projected lubricant management costs, and mixtures thereof.

Another embodiment of the invention includes a machine-readable program storage medium tangibly embodying sequences of instructions, the sequences of instructions for execution by at least one processing system, the sequences of instructions to perform steps for: inputting alphanumeric data into one or more data structures, the data structures configured and adapted for storing, updating, modifying, deleting, and searching data including historical lubricant management costs, historical lubricants volume consumption, projected lubricants volume consumption, projected lubricant management costs, and mixtures thereof; searching at least one of the data structures where the search parameters are selected by a user and include historical date ranges, future date ranges, and mixtures thereof; and forecasting future projections over the user selected future date ranges, the future projections including projected lubricants volume consumption, projected lubricant management costs, and mixtures thereof; where the input for the forecasting includes historical lubricant management costs, historical lubricants volume consumption, and mixture thereof; and displaying on a monitor one or more graphical representations, where the graphical representations include the results of the search of the at least one data structure, the results of the forecasting, and mixtures thereof; where the graphical representations depict historical lubricant management costs, historical lubricants volume consumption, projected lubricants volume consumption, projected lubricant management costs, and mixtures thereof.

These and other features and advantages of the present invention will be made more apparent through a consideration of the following detailed description of a preferred embodiment of the invention. In the course of this description, frequent reference will be made to the attached drawings.

### V. BRIEF DESCRIPTION OF THE DRAWINGS

FIG. 1 is a schematic block system diagram of one embodiment of the invention.

FIG. 2 is a schematic block context diagram of one embodiment of the invention.

FIG. 3 is a schematic process model, level 0 data flow diagram of one embodiment of the invention.

FIG. 4 depicts a conceptual data model in one embodiment of the invention, simplified view of tables, attributes, and relationships for implementing the database aspects of the invention.

### VI. DETAILED DESCRIPTION OF THE DRAWINGS AND PREFERRED EMBODIMENTS

A. Introduction

The following discussion and figures include a general description of a suitable computing environment in which the invention may be implemented. While the invention will be described in the general context of a system and an application program that runs on an operating system in conjunction with general purpose computers, an internet, and web, application, and email servers and clients, those skilled in the art will recognize that the invention also may be implemented in combination with other program modules. Generally, program modules include routines, programs, components, data structures, etc. that performs particular tasks or implement particular abstract data types.

Moreover, those skilled in the art will appreciate that the invention may be practiced with other computer system configurations, including hand-held devices, multiprocessor systems, microprocessor-based or programmable consumer electronics, minicomputers/servers, workstations, mainframe computers, and the like.

The invention may also be practiced in distributed computing environments where tasks are performed by remote processing devices that are linked through a communications network. In a distributed computing environment, program modules may be located in both local and remote memory storage devices.

Then invention generally relates to computer-implemented process and system for a lubricating oil management system. The process aspects of the invention are a series of process steps utilizing, in whole or in part, the system herein and variations thereof. As would be clear to one skilled in the art, the process steps can be embodied in part as code for a computer program for operation on a conventional programmed digital computer, such as a client and server. The program code can be embodied as a computer program on a computer-readable storage medium or as a computer data signal in a carrier wave transmitted over a network.

B. Detailed Description

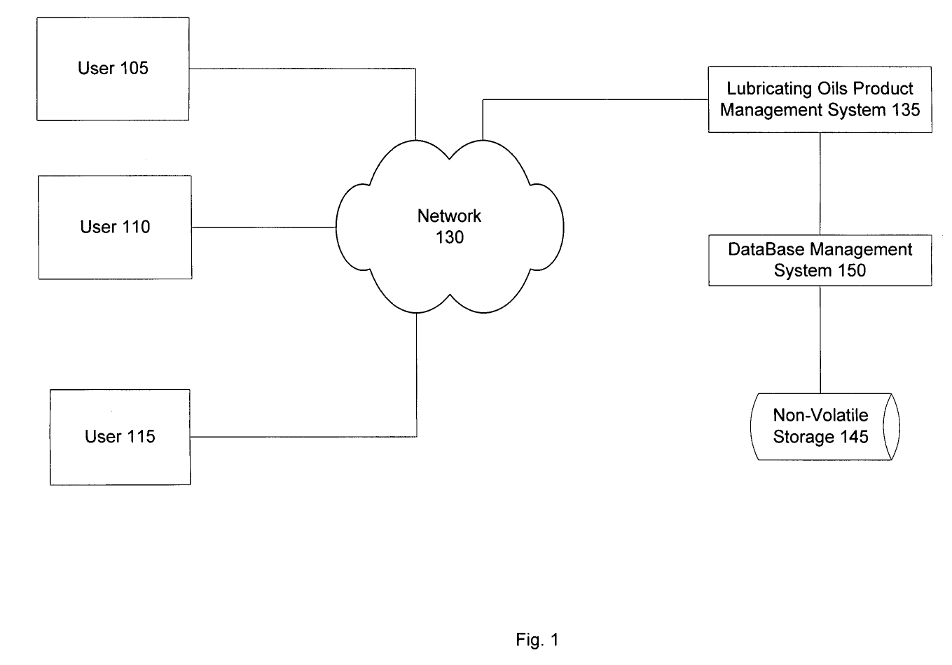

FIG. 1 is a schematic block system diagram of one embodiment of the invention. Each entity involved in the method, in one embodiment, is depicted. The various components and participants using the system are optionally interconnected via Network 130. Alternatively, the system may run on a stand alone PC, workstation, or other type of computer. Various users are depicted as user 105, 110, and 115. Lubricating Oil Products Management System 135 is connected to Network 130, to Relational Database Management System 150, and Non-Volatile Storage 145.

Network 130 is optionally a wired or wireless local area network, a metropolitan area network, or a wide area network, such as the Internet or other public or private networks or combinations thereof. The scope of the network is determined by various factors such as distance between network nodes, security, data traffic demands, desired response times, and other known network engineering considerations. The communication of all entities through a common Network 130 is illustrative only, and the invention includes embodiments where some entities communicate through one network, other entities through a different network, and various permutations thereof.

The communication links between the nodes preferably comprise a cable, fiber or wireless link on which electronic signals can propagate. For example, each node may be connected via a local area network using a 10 Mbps, 100 Mbps, or 1 Gbps Ethernet protocol. A wide area network may use an Internet connection using TCP/IP protocols over a public switched telephone network (PSTN), such as those provided by a local or regional telephone operating company. Alternatively, each node may be connected by dedicated data lines, cellular, Personal Communication Systems (“PCS”), microwave, or satellite networks.

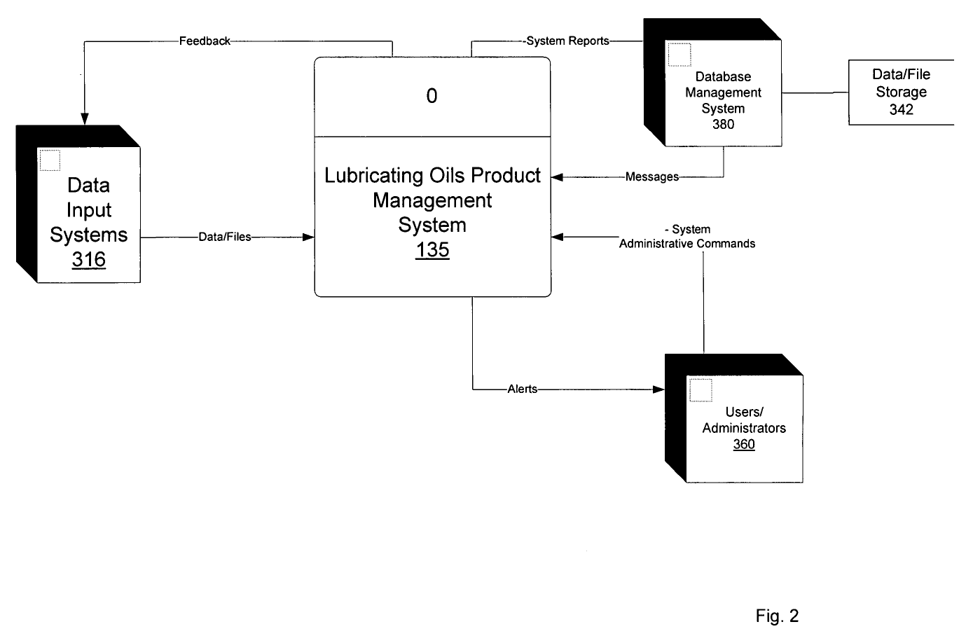

FIG. 2 is a schematic block context diagram of one embodiment of the invention. This is a related but alternative view to that of FIG. 1. In FIG. 2, the Lubricating Oil Products Management System 135 is shown at the center. Those blocks on surrounding and connected to the Lubricating Oil Products Management System 135 interact with it in some way, typically, either receiving data or services from, or providing data or services to, Lubricating Oil Products Management System 135. Data Input Systems 316 provides data or files to Lubricating Oil Products Management System 135. Data base management system (“DBMS”) block 380 depicts the “back end” storage and maintenance portions of the DBMS (block 150 in FIG. 1).

Various queries and commands pass from Lubricating Oil Products Management System 135 to DBMS 380 and various responses to those queries and commands pass back to Lubricating Oil Products Management System from DBMS 380. Commands received would include creating or searching records stored in Data/File storage 342. Data/File storage 342 is any conventional hardware and/or software for storing data of database in known architectures of relational databases.

Files are stored in and retrieved from Physical Data/File Storage 342. Users/administrators 360 access GUI 135 and perform such actions as enter or select data, retrieve files, or perform system administration. Typically responses or file transfer of DBMS 380 are in response to queries posed by users/administrators 360 but are not so limited. That is, business rules for automatic generation or delivery of reports or files may be included, e.g., regularly scheduled status reports.

### C. Method of Use of The System

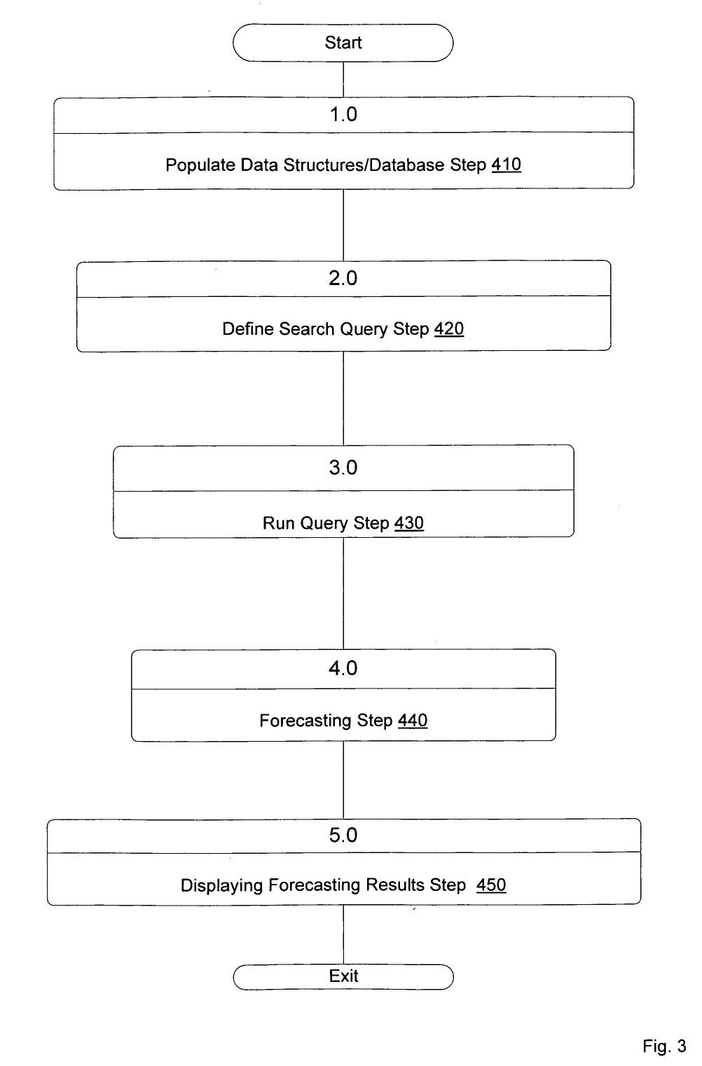

FIG. 3 is a schematic process model, level 0 data flow diagram of one embodiment of the invention. A user or system administrator populates the data structures in Step 410. The selected metadata used to populate the data structures is specific to the data of interest, e.g., data for specific oil products, applications, projects, customers, and/or volumes or prices. Selection or query definition is done by any conventional means in step Define Search Query step 420. This includes, e.g., selections via drop-down boxes, entering text into a text box, selecting check boxes or radio buttons.

After the metadata is entered or query defined it is next translated into a DBMS compatible form (step not shown). This comprises storing the selected metadata or query terms and writing those terms into the command-line form compatible for the specific DBMS being used. Various implementations of this functionality are possible using conventional programming methods. Typically, a DBMS provides API methods for facilitating this translation.

In step 430, the DMBS runs the query and locates files meeting the query conditions. The DMBS returns a query report to the Lubricating Oils Product Management System which displays it to the user. The report optionally contains a selectable list of files meeting the query. Selection is by any conventional means of GUI technology as discussed above relative to Define Query Step 420. The query results are passed to Forecasting step 440 where it is processed and produces a forecast as selected by the user, e.g., forecasted volume usage or cost information for a selected time period. Lastly, the result is displayed to the user in Displaying Forecasting Results step 450. The results are displayed by any conventional means, e.g., graphical, tabular, or other report style.

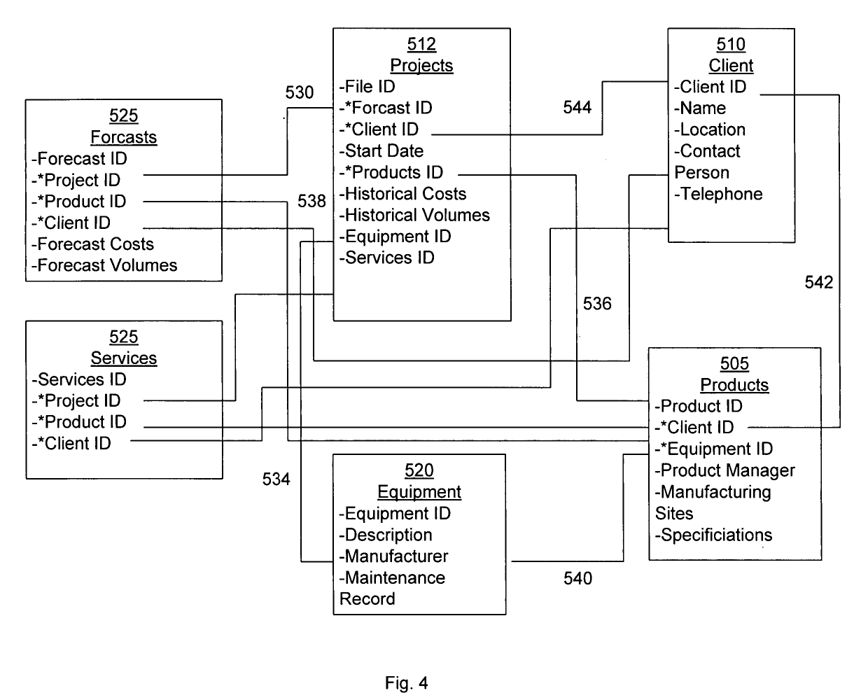

FIG. 4 depicts a conceptual data model in one embodiment of the invention, simplified view of tables, attributes, and relationships for implementing the database aspects of the invention. That is, the metadata can be stored in various tables. In this exemplary conceptual data model there are six tables—Forecasts Table 525, Projects Table 512, Client Table 510, Products Table 505, Equipment Table 520, and Services Table 525. Each table contains one or more attributes, at least one of which is a primary key for uniquely identifying a specific record (i.e., row) in that table.

Each table is linked to (i.e., is related to) at least one other by a foreign key. With such a data model, a user can, e.g., search for all files of a specific client or all files identifying certain projects or all files of a certain date, and various combination or permutations of such searches which are well known to those skilled in relational database design and administration. Modification of the shown tables as well as additional tables, their domains, keys, and links to other tables, and associated queries and reports, and appropriate normalization of each, useful in implementing the databases used in the invention, given the disclosure herein, could be implemented by data base designers of ordinary skill in the art.

C. Other Implementation Details

1. Terms

The detailed description contained herein is represented partly in terms of processes and symbolic representations of operations by a conventional computer and/or wired or wireless network. The processes and operations performed by the computer include the manipulation of signals by a processor and the maintenance of these signals within data packets and data structures resident in one or more media within memory storage devices. Generally, a “data structure” is an organizational scheme applied to data or an object so that specific operations can be performed upon that data or modules of data so that specific relationships are established between organized parts of the data structure.

A “data packet” is type of data structure having one or more related fields, which are collectively defined as a unit of information transmitted from one device or program module to another. Thus, the symbolic representations of operations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, data, packets, nodes, numbers, points, entries, objects, images, files or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as issuing, sending, altering, adding, disabling, determining, comparing, reporting, and the like, which are often associated with manual operations performed by a human operator. The operations described herein are machine operations performed in conjunction with various inputs provided by a human operator or user that interacts with the computer.

2. Hardware

It should be understood that the programs, processes, methods, etc. described herein are not related or limited to any particular computer or apparatus, nor are they related or limited to any particular communication architecture, other than as described. Rather, various types of general purpose machines, sensors, transmitters, receivers, transceivers, and network physical layers may be used with any program modules and any other aspects of the invention constructed in accordance with the teachings described herein. Similarly, it may prove advantageous to construct a specialized apparatus to perform the method steps described herein by way of dedicated computer systems in specific network architecture with hard-wired logic or programs stored in nonvolatile memory, such as read-only memory.

3. Program

In the preferred embodiment where any steps of the present invention are embodied in machine-executable instructions, the instructions can be used to cause a general-purpose or special-purpose processor which is programmed with the instructions to perform the steps of the present invention. Alternatively, the steps of the present invention might be performed by specific hardware components that contain hardwired logic for performing the steps, or by any combination of programmed computer components and custom hardware components.

The foregoing system may be conveniently implemented in a program or program module(s) that is based upon the diagrams and descriptions in this specification. No particular programming language has been required for carrying out the various procedures described above because it is considered that the operations, steps, and procedures described above and illustrated in the accompanying drawings are sufficiently disclosed to permit one of ordinary skill in the art to practice the present invention.

Moreover, there are many computers, computer languages, and operating systems which may be used in practicing the present invention and therefore no detailed computer program could be provided which would be applicable to all of these many different systems. Each user of a particular computer will be aware of the language and tools which are most useful for that user's needs and purposes.

The invention thus can be implemented by programmers of ordinary skill in the art without undue experimentation after understanding the description herein.

4. Product

The present invention is composed of hardware and computer program products which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions. Moreover, the software portion of the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

5. Components

The major components (also interchangeably called aspects, subsystems, modules, functions, services) of the system and method of the invention, and examples of advantages they provide, are described herein with reference to the figures. For figures including process/means blocks, each block, separately or in combination, is alternatively computer implemented, computer assisted, and/or human implemented. Computer implementation optionally includes one or more conventional general purpose computers having a processor, memory, storage, input devices, output devices and/or conventional networking devices, protocols, and/or conventional client-server hardware and software. Where any block or combination of blocks is computer implemented, it is done optionally by conventional means, whereby one skilled in the art of computer implementation could utilize conventional algorithms, components, and devices to implement the requirements and design of the invention provided herein. However, the invention also includes any new, unconventional implementation means.

6. Web Design

Any web site aspects/implementations of the system include conventional web site development considerations known to experienced web site developers. Such considerations include content, content clearing, presentation of content, architecture, database linking, external web site linking, number of pages, overall size and storage requirements, maintainability, access speed, use of graphics, choice of metatags to facilitate hits, privacy considerations, and disclaimers.

7. Other lmplementations

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive. It is therefore not intended that the invention be limited except as indicated by the appended claims.

What is claimed is:

1. A system for lubricating oils product management, the system comprising:
a. a CPU;
b. a memory operatively connected to the CPU, the memory containing a program adapted to be executed by the CPU and the CPU and memory cooperatively adapted for lubricating oils product management;
c. a lubricating oils product management code segment embodied on a computer-readable medium configured and adapted for:
i. inputting alphanumeric data into one or more data structures, the data structures configured and adapted for storing, updating, modifying, deleting, and searching data comprising historical lubricant management costs, historical lubricants volume consumption, projected lubricants volume consumption, projected lubricant management costs, and mixtures thereof;
ii. searching at least one of the data structures wherein the search parameters are selected by a user and comprise historical date ranges, future date ranges, and mixtures thereof; and
iii. forecasting future projections over the user selected future date ranges, the future projections comprising projected lubricants volume consumption, projected lubricant management costs, and mixtures thereof;
wherein the input for the forecasting comprises historical lubricant management costs, historical lubricants volume consumption, and mixture thereof; and
iv. displaying on a monitor one or more graphical representations, where the graphical representations comprise the results of the search of the at least one data structure, the results of the forecasting, and mixtures thereof; wherein the graphical representations depict historical lubricant management costs, historical lubricants volume consumption, projected lubricants volume consumption, projected lubricant management costs, and mixtures thereof.

2. The system of claim 1, further comprising a code segment configured and adapted for data structures for storing, updating, modifying, deleting, and searching data comprising manpower, equipment, customer details, added value services, product profile, site service audit, site management, improvement initiatives, fluid management agreement, summary, and mixtures thereof.

3. The system of claim 1, wherein the search parameters code segment further comprises manpower, equipment, customer details, added value services, product profile, site service audit, site management, improvement initiatives, fluid management agreement, summary, and mixtures thereof.

4. The system of claim 1, wherein the graphical representation of the searching results code segment further comprise user input constructs for allowing a user to change one or more search parameters.

5. The system of claim 1, wherein the forecasting future projections code segment further comprises an inflation indexing code segment for adjusting costs.

6. A method for lubricating oils product management comprising:
a. inputting alphanumeric data into one or more data structures, the data structures configured and adapted for storing, updating, modifying, deleting, and searching data comprising historical lubricant management costs, historical lubricants volume consumption, projected lubricants volume consumption, projected lubricant management costs, and mixtures thereof;
b. searching at least one of the data structures wherein the search parameters are selected by a user and comprise historical date ranges, future date ranges, and mixtures thereof; and
c. forecasting future projections over the user selected future date ranges, the future projections comprising projected lubricants volume consumption, projected lubricant management costs, and mixtures thereof; wherein the input for the forecasting comprises historical lubricant management costs, historical lubricants volume consumption, and mixture thereof; and
d. displaying on a monitor one or more graphical representations, where the graphical representations comprise the results of the search of the at least one data structure, the results of the forecasting, and mixtures thereof; wherein the graphical representations depict historical lubricant management costs, historical lubricants volume consumption, projected lubricants volume consumption, projected lubricant management costs, and mixtures thereof.

7. The method of claim 6, further comprising inputting data comprising manpower, equipment, customer details, added value services, product profile, site service audit, site management, improvement initiatives, fluid management agreement, summary, and mixtures thereof.

8. The method of claim 6, wherein the search parameters further comprise manpower, equipment, customer details, added value services, product profile, site service audit, site management, improvement initiatives, fluid management agreement, summary, and mixtures thereof.

9. The method of claim 6, further comprising displaying user input constructs for allowing a user to change one or more search parameters.

10. The method of claim 6, wherein the forecasting future projections step further comprises adjusting costs according to an inflation index.

11. A machine-readable program storage medium tangibly embodying sequences of instructions, the sequences of instructions for execution by at least one processing system, the sequences of instructions to perform steps for:
a. inputting alphanumeric data into one or more data structures, the data structures configured and adapted for storing, updating, modifying, deleting, and searching data comprising historical lubricant management costs, historical lubricants volume consumption, projected lubricants volume consumption, projected lubricant management costs, and mixtures thereof;
b. searching at least one of the data structures wherein the search parameters are selected by a user and comprise historical date ranges, future date ranges, and mixtures thereof; and
c. forecasting future projections over the user selected future date ranges, the future projections comprising projected lubricants volume consumption, projected lubricant management costs, and mixtures thereof; wherein the input for the forecasting comprises historical lubricant management costs, historical lubricants volume consumption, and mixture thereof; and
d. displaying on a monitor one or more graphical representations, where the graphical representations comprise the results of the search of the at least one data structure, the results of the forecasting, and mixtures thereof; wherein the graphical representations depict historical lubricant management costs, historical lubricants volume consumption, projected lubricants volume consumption, projected lubricant management costs, and mixtures thereof.

12. The machine-readable program storage medium of claim 11, wherein the inputting step further comprises inputting alphanumeric data into data structures for storing, updating, modifying, deleting, and searching data comprising manpower, equipment, customer details, added value services, product profile, site service audit, site management, improvement initiatives, fluid management agreement, summary, and mixtures thereof.

13. The machine-readable program storage medium tangibly of claim 11, wherein the search parameters further comprise manpower, equipment, customer details, added value services, product profile, site service audit, site management, improvement initiatives, fluid management agreement, summary, and mixtures thereof.

14. The machine-readable program storage medium of claim 11, wherein the graphical representation of the searching results further comprises user input constructs for allowing a user to change one or more search parameters.

15. The machine-readable program storage medium of claim 11, wherein the forecasting future projections step further comprises adjusting costs according to an inflation index.
